(19) United States
(12) Patent Application Publication
(10) Pub. No.: US 2018/0294629 A1
(43) Pub. Date: Oct. 11, 2018

(54) DEVICE AND METHOD FOR SPLICING SHIELDED WIRE CABLES

(71) Applicant: Delphi Technologies, Inc., Troy, MI (US)

(72) Inventors: Thomas A. Volpone, Cortland, OH (US); Troy .A Iler, Salem, OH (US)

(21) Appl. No.: 15/480,472

(22) Filed: Apr. 6, 2017

(51) Int. Cl. H02G 1/00; H01B 7/00; H01B 17/66; H02G 15/113

(52) U.S. Cl. CPC H02G 1/005; H02G 15/113; H01B 17/66; H01B 7/0045

(57) ABSTRACT

A wire cable assembly, such as those used in electric or hybrid electric vehicles, having a plurality of shielded wire cables that are spliced together is presented. The assembly incudes a splicing device having a generally planar bus bar formed of a conductive material enclosed within an insulative inner housing. The inner housing is preferably tamper proof. The exposed core conductors of the shielded wire cables are welded to the bus bar, thereby electrically interconnecting the exposed core conductors. A conductive sleeve encloses bus bar and interconnects the shield conductors of the shielded wire cables, providing shielding for the exposed core conductors and continuity for the shield conductors. An outer insulator enclosing the conductive sleeve. A method of splicing shielded wire cables using such a device is also presented herein.

### TECHNICAL FIELD OF THE INVENTION

The invention generally relates to a splicing device and a method for joining shielded wire cables.

### BACKGROUND OF THE INVENTION

Shielded wire cables typically include an insulated center conductor and a separate insulated shield conductor surrounding the center conductor insulation. The shield conductor may consist of a braided wire mesh, metal foil, or metalized film. The cables typically have a second insulation layer covering the shield conductor. Shielded wire cables have been long used for communications systems, such as in cable television transmission lines. Shielded wire cables are also finding use in high voltage applications in electric and hybrid electric vehicles. When shielded wire cables are spliced together, there is usually a need to electrically connect the shield conductors of the spliced cables as well as the center conductor, in order to maintain electrical continuity of the shield conductors. Interconnecting the shield conductors may be complicated because the shield conductors must be cut back from the spliced ends of the cable in order to join the center conductors. Interconnecting the shield conductors may be further complicated in a one-to-many splicing configuration, sometimes referred to as a Y-splice or H-splice.

A splicing device and a method for splicing shielded wire cables is described in U.S. Patent Publication No. 2015/0229115 published Aug. 13, 2015, herein incorporated by reference in it entirely. According to the splicing device 10 shown in FIGS. 1A and 1B, the core conductors 12 of the shielded cables 14 are spliced together by sonically welding them to one another and placed within an inner insulator 16 that insulates the welded core conductors 18. The inner insulator is placed inside a conductive sleeve, i.e. a shield 20, that interconnects conductive ferrules 22 attached to the shield conductors of the shielded cables 14, thereby providing electrical continuity of the shield conductors 14 over the spliced core conductors 18. The shield 20 is placed inside an outer insulator, i.e. an outer insulator 24 that incudes cable seals 26 and end caps 28 to retain the seals 26 within the outer insulator 24. This splicing device 10 requires a “fan out” of the core conductors 12 from the welded splice 18. This “fan-out” increases the length of cable required and increase the overall length of the splicing device 10.

Therefore, an alternative splicing device and a method of splicing shielded cables that reduces the overall cable and splicing device length remains desired.

As of the time of filing this application, the invention described in this application and the invention described in U.S. Patent Publication No. 2015/0229115 are co-owned by Delphi Technologies, Inc.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

### BRIEF SUMMARY OF THE INVENTION

In accordance with one embodiment of this invention, a wire harness assembly is provided. The wire harness assembly includes a first shielded wire cable having a first exposed shield conductor and a first exposed core conductor, a second shielded wire cable having a second exposed shield conductor and a second exposed core conductor, and a third shielded wire cable having a third exposed shield conductor and a third exposed core conductor, and a generally planar bus bar formed of a conductive material. The first, second, and third exposed core conductors are welded to the bus bar, thereby electrically connecting the first, second, and third exposed core conductors. The wire harness assembly further includes a conductive sleeve enclosing a portion of the first, second, and third exposed shield conductors, an inner insulator enclosing the bus bar and disposed within the conductive sleeve, and an outer insulator enclosing the conductive sleeve.

The inner insulator may further include a first portion having a substantially rigid first wall defining a first locking feature and a substantially rigid second wall, wherein the first locking feature includes a first contact surface and a first locking surface intersecting the first contact surface and a second portion having a flexible arm defining a second locking feature. The second locking feature includes a second contact surface and a second locking surface intersecting the second contact surface. The first contact surface engages the second contact surface causing the flexible arm to bend as the first portion is joined to the second portion. The second wall limits bending of the flexible arm. The first locking feature and/or the second locking feature at least temporarily deforms when the bending of the flexible arm is limited by the second wall as the first portion is joined to the second portion. This deformation disengages the first contact surface from the second contact surface and thereby allows the first locking surface to engage with the second locking surface. The second wall may be defined by the second portion and may substantially parallel to the flexible arm. The first wall may be in contact with a substantially rigid third wall defined by the second portion. The first and second portions are preferably formed of an insulative polymeric material.

In accordance with another embodiment of this invention, method of splicing shielded wire cables together is provided. The method includes the steps of:
providing a first shielded wire cable having a first exposed shield conductor and a first exposed core conductor;
providing a second shielded wire cable having a second exposed shield conductor and a second exposed core conductor;
providing a third shielded wire cable having a third exposed shield conductor and a third exposed core conductor;
providing a first, second, and third ferrule;
attaching the first, second, and third to the first, second, and third shield conductors respectively;
providing a generally planar bus bar formed of a conductive material;
providing a conductive sleeve;
providing an inner insulator formed of a thermoplastic material;
disposing the bus bar within the inner insulator;
welding the first, second, and third exposed core conductors to the bus bar, thereby electrically connecting the first, second, and third exposed core conductors;
disposing the inner insulator and the first, second, and third exposed shield conductors within the conductive sleeve;
attaching the first, second, and third ferrules to the conductive sleeve, thereby providing a conductive path between the first, second, and third exposed shield conductors;
providing an outer insulator formed of a nonconductive material; and
disposing the conductive sleeve within the outer insulator.

The inner insulator may further include a first portion having a substantially rigid first wall defining a first locking feature and a substantially rigid second wall and a second portion having a flexible arm defining a second locking feature, wherein the first locking feature includes a first contact surface and a first locking surface intersecting the first contact surface, wherein the second locking feature includes a second contact surface and a second locking surface intersecting the second contact surface, and wherein the method further comprises the steps of:
applying a force to the first and second portions;
bending the flexible arm by engaging the first contact surface with the second contact surface as the force is applied to the first and second portions, wherein the second wall limits bending of the flexible arm;
at least temporarily deforming the first locking feature and/or the second locking feature as the bending of the flexible arm is limited by the second wall as the force is applied to the first and second portions;
disengaging the first contact surface from the second contact surface as the force is applied to the first and second portions; and
engaging the first locking surface with the second locking surface.

The second wall may be defined by the second portion and may substantially parallel to the flexible arm. The first wall may be in contact with a substantially rigid third wall defined by the second portion. The first and second portions are preferably formed of an insulative polymeric material.

In accordance with yet another embodiment of this invention, a housing is provided. The housing includes a first portion having a substantially rigid first wall defining a first locking feature and a substantially rigid second wall, wherein the first locking feature includes a first contact surface and a first locking surface intersecting the first contact surface and a second portion having a flexible arm defining a second locking feature. The second locking feature includes a second contact surface and a second locking surface intersecting the second contact surface. The first contact surface engages the second contact surface causing the flexible arm to bend as the first portion is joined to the second portion. The second wall limits bending of the flexible arm. The first locking feature and/or the second locking feature at least temporarily deforms when the bending of the flexible arm is limited by the second wall as the first portion is joined to the second portion. This deformation disengages the first contact surface from the second contact surface and thereby allows the first locking surface to engage with the second locking surface. The second wall may be defined by the second portion and may substantially parallel to the flexible arm. The first wall may be in contact with a substantially rigid third wall defined by the second portion. The first and second portions are preferably formed of an insulative polymeric material.

The second wall may be defined by the second portion and may substantially parallel to the flexible arm. The first wall may be in contact with a substantially rigid third wall defined by the second portion. The first and second portions are preferably formed of an insulative polymeric material.

Further features and advantages of the invention will appear more clearly on a reading of the following detailed description of the preferred embodiment of the invention, which is given by way of non-limiting example only and with reference to the accompanying drawings.

### BRIEF DESCRIPTION OF THE SEVERAL VIEWS OF THE DRAWING

The present invention will now be described, by way of example with reference to the accompanying drawings, in which:

FIG. 1A is an exploded view of a shielded wire harness assembly having a spliced joint in accordance with the prior art;

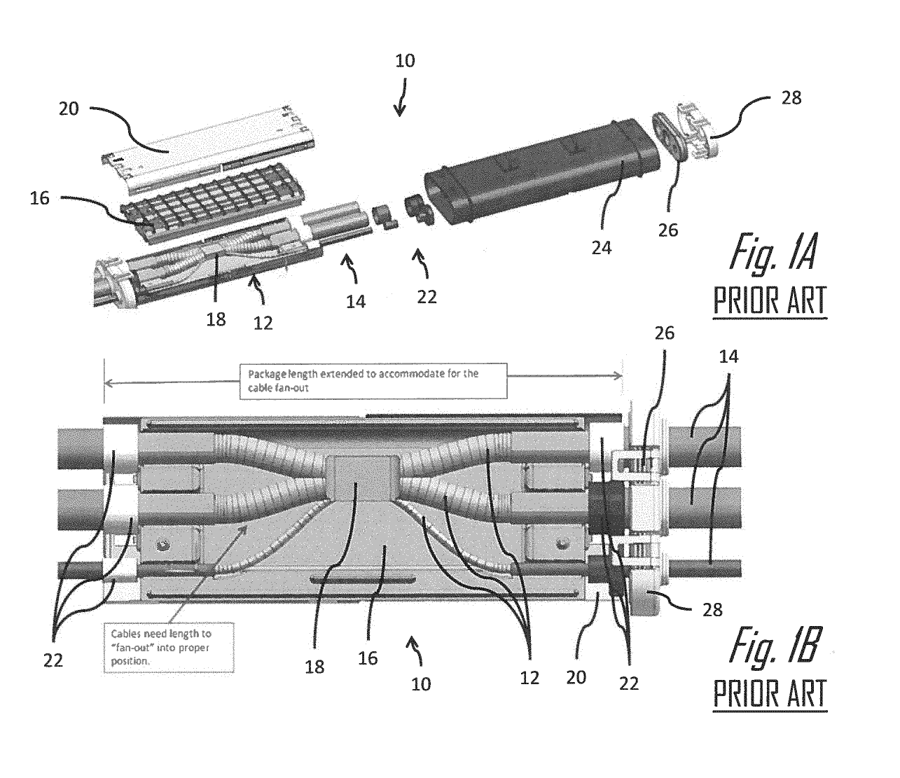

FIG. 1B is a cut away view of the shielded wire harness assembly of FIG. 1A in accordance with the prior art;

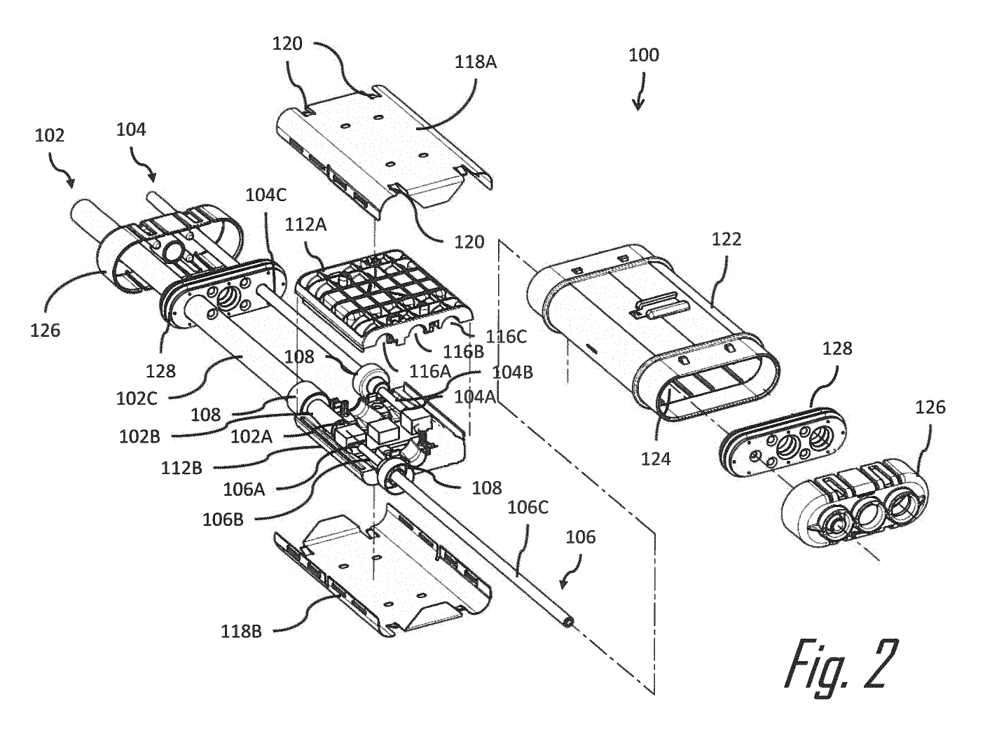

FIG. 2 is an exploded view of a shielded wire harness assembly having a spliced joint in accordance with a first embodiment;

FIG. 3 is a cut away view of an inner insulator of the shielded wire harness assembly of FIG. 2 illustrating a tamper resistant locking feature in accordance with the first embodiment;

FIG. 4 is partial cut away assembly view of the inner insulator of FIG. 3 in an unassembled condition in accordance with the first embodiment;

FIG. 5 is partial cut away assembly view of the inner insulator of FIG. 3 in a partially assembled condition in accordance with the first embodiment;

FIG. 6 is partial cut away assembly view of the inner insulator of FIG. 3 in a fully assembled condition in accordance with the first embodiment; and

FIG. 7 is a flow chart of a method of splicing shielded wire cables together in accordance with a third embodiment.

### DETAILED DESCRIPTION OF THE INVENTION

Described herein are devices and a methods for splicing two or more shielded wire cables together. The devices and methods may be used to splice shielded wire cables with a single center conductor, i.e. solid wire, or multiple center connectors, i.e. stranded wire. The devices and methods described herein may also be used to splice two or more shielded wire cables to form a H-splice or Y-splice. The devices and methods described herein may be used for splicing a variety of shielded wire cables types, for example high voltage shielded wire cables designed for electrical or hybrid electrical vehicles.

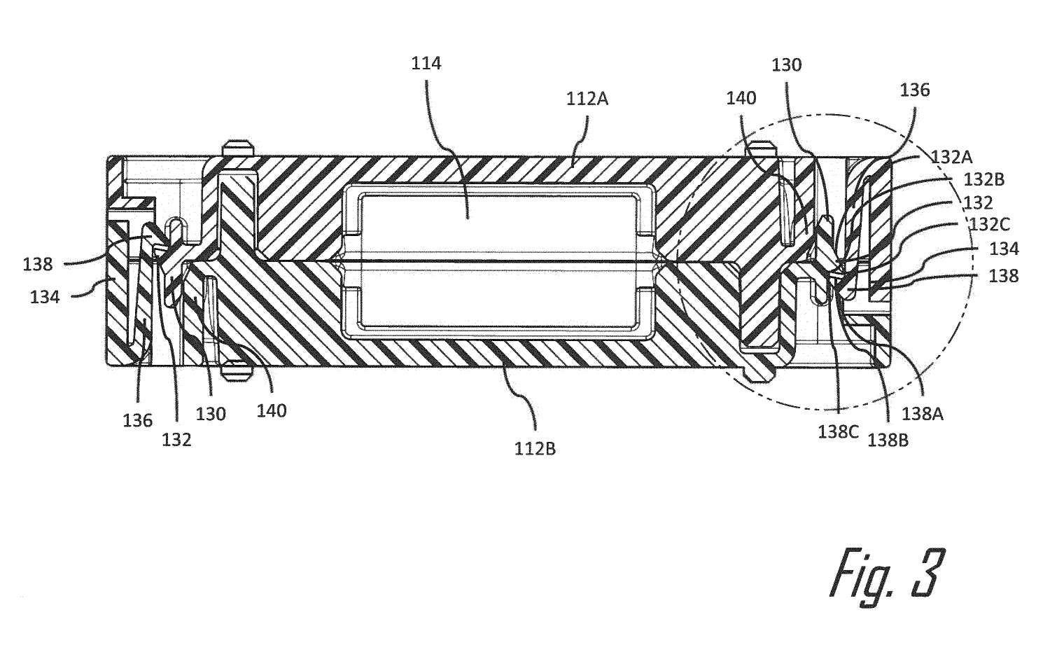

FIG. 2 illustrates a non-limiting example of a wire harness assembly, hereinafter referred to as the assembly 100 that includes three cut lead shielded wire cables 102, 104, 106 that are spliced together in a Y-splice configuration. The assembly 100 includes a device configured to make a splice connection between the three shielded wire cables 102, 104, 106, hereinafter referred to as a splicing device. The three shielded wire cables 102, 104, 106 each have a core conductor 102A, 104A, 106A respectively that is axially surrounded by an inner insulation jacket 102B, 104B, 106B respectively. The inner insulation jackets 102B, 104B, 106B are axially surrounded by a shield conductor (not shown) respectively. The shield conductors are axially surrounded by an outer insulation jacket 102C, 104C, 106C respectively. The core conductors 102A, 104A, 106A are preferably formed of a stranded, i.e. multi-wire core but may also be formed of a solid single wire core. The shield conductors are preferably formed of a woven wire mesh, but may also be formed of an electrical conductive foil, e.g. a copper foil, aluminum foil, or a metallized plastic foil.

As illustrated in FIG. 2, a portion of the inner insulation jackets 102B, 104B, 106B, shield conductors, and outer insulation jackets 102C, 104C, 106C, are removed to expose a portion of the core conductors 102A, 104A, 106A. The ends of the cut leads are stripped to expose a portion of the core conductors 102A, 104A, 106A.

An additional portion of each of the shield conductors may be removed or cut way to provide adequate voltage creepage distance to prevent a leakage current between the core conductors 102A, 104A, 106A and the shield conductors thereby exposing inner insulation jackets 102B, 104B, 106B of the shielded cables 102, 104, 106. The exposed shield conductors are folded back over the outer insulation jackets 102C, 104C, 106C and an inner ferrule (not shown) is placed between the inner insulation jackets 102B, 104B, 106B and the exposed shield conductors of each of the shielded wire cables 102, 104, 106 and an outer ferrule 108 is placed over each of the exposed shield conductors to provide a robust connection point for the shield conductors. The ferrules 108 may be a closed or barrel-type ferrule that is attached to the shield conductors by crimping or soldering prior to forming the connection or the ferrules 108 may be an open or clip-type ferrule that can be attached to the shield conductors by crimping after forming the connection. Materials and methods used to attach the conductive ferrules 108 to the shield conductors are well known to those skilled in the art.

The exposed portions of the core conductors 102A, 104A, 106A are attached to an electrically conductive bus bar 110 to electrically interconnect the core conductors 102A, 104A, 106A. The bus bar 110 has a generally rectangular shape and the core conductors 102A, 104A, 106A are attached to one of the major surfaces of the bus bar 110 by a welding process, preferably a sonic welding process although other welding processes such as resistance welding, soldering, brazing may be employed. The bus bar 110 may be formed of a copper or aluminum based alloy. When the cables 102, 104, 106 are cut in cut leads, the core conductors 102A, 104A, 106A are stacked or piggy-backed on one another when welded to the bus bar 110.

The assembly 100 includes an inner insulator , hereinafter referred to as an inner housing 112 formed of dielectric material. The dielectric material may be a polymer material, such as glass-filled polyamide (commonly known by the trade name NYLON) or polybutylene terephthalate (PBT). The inner housing 112 may be formed using an injection molding process or other plastic forming processes well known to those skilled in the art. The inner housing 112 may be formed by two identical halves, and upper inner housing 112A and a lower inner housing 112B that are designed to enclose the bus bar 110, the exposed core conductors 102A, 104A and the exposed inner insulation jackets 102B, 104B of the shielded cables 102, 104.

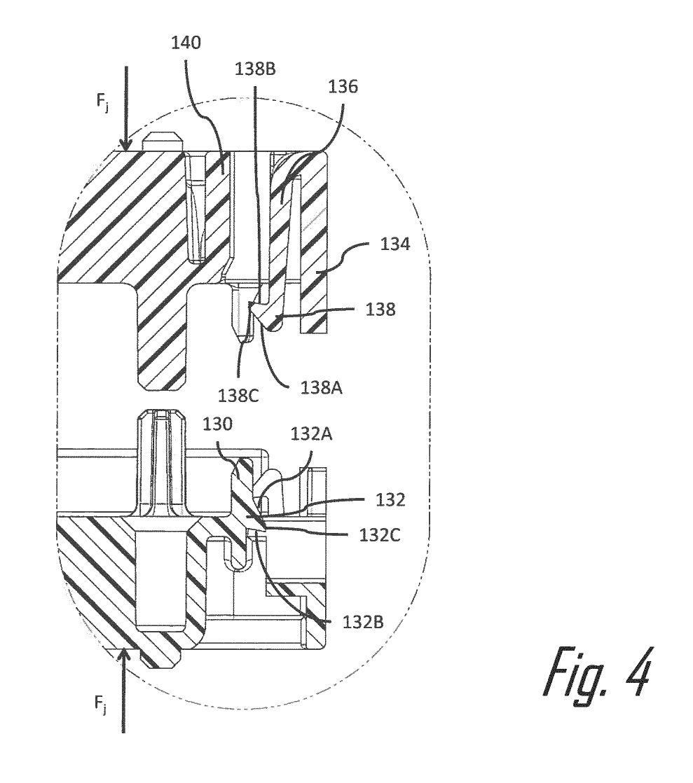

The inner housing 112 defines a lateral cavity 114 that is designed to accommodate the bus bar 110. The inner housing 112 also defines three longitudinal cavities 116A, 116B, 116C extending from the lateral cavity 114 that are designed to accommodate the shielded cables 102, 104, 106. As shown in FIG. 3, the size of the longitudinal cavities 116A, 116B, 116C may vary to accommodate shielded cables 102, 104, 106 having different diameters.

The assembly 100 further includes a sleeve 118 formed of conductive material in which the inner housing 112 is enclosed. The conductive material used to form the sleeve 118 is preferably a copper alloy, such as 425 brass and may be tin coated for corrosion resistance. The sleeve 118 defines contacts 120 that are designed to be in mechanical and electrical contact with the outer ferrules 108 attached to the shield conductors of the shielded wire cables 102, 104, 106. The contacts 120 protrude from the sleeve 118 and form an arcuate shape configured to exert a spring force on the outer ferrules 108.

As shown in FIG. 2, the sleeve 118 is made up of a first sleeve portion 118A that defines a first set of contacts 120 and a second sleeve portion 118B that defines a second set of contacts 120. The first sleeve portion 118A is configured to enclose the inner housing 112 when mated with the second sleeve portion 118B. Features may be included in the joining surfaces of the first sleeve portion 118A and the second sleeve portion 118B to reduce electrical resistance between the two sleeve portions 118A, 118B. Alternatively, the first sleeve portion 118A and the second sleeve portion 118B may be secured together using conductive threaded fasteners. The first and second sleeve portions 118A, 118B may be designed with a hermaphroditic shape so that a single part may be used for both the first and second sleeve portions 118A, 118B. The inner housing 112 may also be designed to have first and second portions with a hermaphroditic shape so that a single part may be used for both portions.

The assembly 100 further includes an outer insulator, hereinafter referred to as an outer housing 122 formed of a nonconductive material and defining a cavity 124 that is configured to enclose the sleeve 118. The assembly 100 also includes a pair of end caps 126 that are designed to sealably engage the shielded wire cables 102, 104, 106 and sealably engage the outer housing 122. The end caps 126 and outer housing 122 are designed to provide environmental protection by keeping contaminants such as dust, dirt, water, and other fluids away from to the exposed core conductors 102A, 104A, 106A, bus bar 110, and sleeve 118. The outer housing 122 and end caps 126 may be formed of a polymer material, such as NYLON or PBT. The end caps 126 may also include a sealing element formed of compliant material, such as silicone rubber, hereinafter referred to as seals 128.

Since the connections between the exposed core conductors 102A, 104A, 106A and the bus bar 110 are not serviceable, it is desirable to provide a tamper resistant locking feature to secure the upper inner housing 112A to the lower inner housing 112B so that they may not be separated once joined to reduce the chance of accidental contact with an energized core conductors 102A, 104A, 106A or bus bar 110.

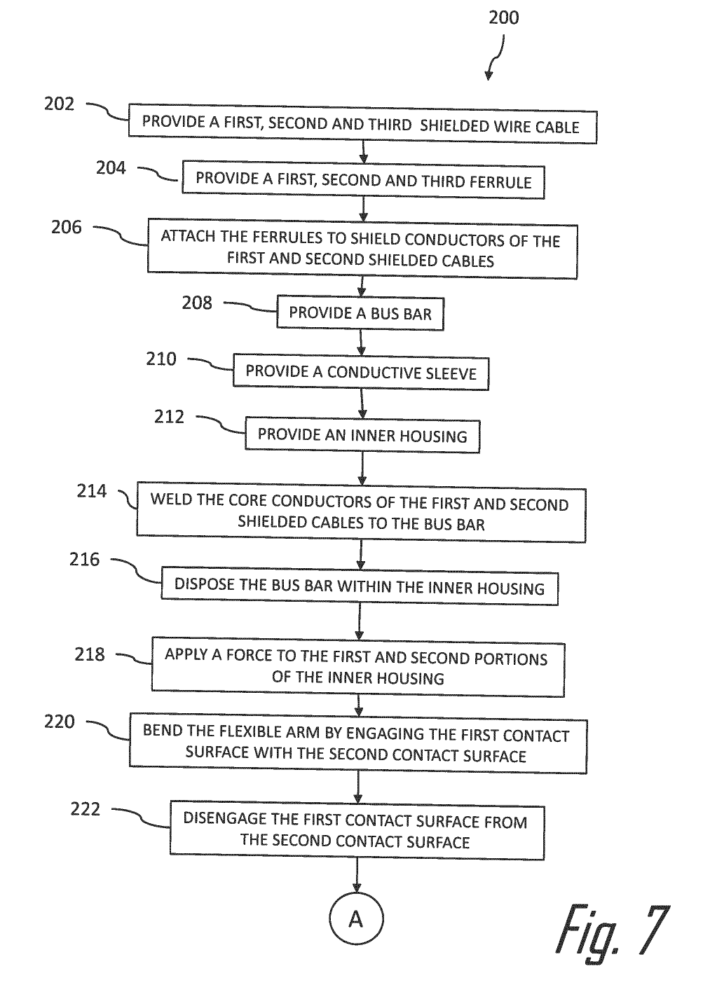

FIGS. 3-6 illustrate a non-limiting example of such a tamper resistant locking feature. As will be explained below, this locking feature is configured to be easily assembled and once assembled is very difficult to separate.

FIG. 3 illustrates the inner housing 112 in a fully assembled condition. As shown on the right side of FIG. 3 (circled portion), the lower inner housing 112B has a substantially rigid first wall 130 that defines a first locking feature 132 and a substantially rigid second wall 134. The first locking feature 132 of the lower inner housing 112B includes a first contact surface 132A and a first locking surface 132B intersecting the first contact surface 132A. Together the first contact surface 132A and the first locking surface 132B form an edge, or lip, or groove, or catch that forms the first locking feature 132 of the lower inner housing 112B. The first contact surface 132A and the first locking surface 132B define a first angle. Additionally, the upper inner housing 112A has a resilient flexible arm 136 that defines a second locking feature 138 corresponding to the first locking feature 132. The second locking feature 138 includes a second contact surface 138A and a second locking surface 138B intersecting the second contact surface 138A. Together the second contact surface 138A and the second locking surface 138 form an edge, or lip, or groove, or catch that forms the second locking feature 138 of the upper inner housing 112A. The second contact surface 138A and the second locking surface 138 define a second angle. For instance, the first contact surface 132A of the first locking feature 132 may slope with respect to the intersecting first locking surface 132B at an angle that ranges from 0 to about 90 degrees, such as from about 5 or about 10 degrees to about 80 or 85 degrees, for instance, from about 15 or 20 degrees to about 70 or 75 degrees, such as from about 30 or 40 degrees to about 50 or 60 degrees, including about 45 degrees.

As shown on the left side of FIG. 3, the upper inner housing 112A also includes a first locking feature 132 and the lower inner housing 112B also includes a second locking feature 138.

Accordingly, the first locking feature 132 of the lower inner housing 112B is configured to engage the corresponding the second locking feature 138 of the upper inner housing 112A. The first and second locking features 132, 138 may have corresponding first and second contact surfaces 132A, 138A and corresponding first and second locking surfaces 132B, 138B or may have different, but complimentary surfaces. In the illustrated example, the lower inner housing 112B has the first locking feature 132 that includes a lip or edge region 132C that comprises the first locking surface 132B that is intersected by the first contact surface 132A. Likewise, the upper inner housing 112A has a second locking feature 138 that includes a lip or edge region 138C that comprises the second locking surface 138 that is intersected by the second contact surface 138A. In this embodiment, the corresponding first and second locking surfaces 132B, 138B are configured for being coupled together when the upper inner housing 112A is joined to the lower inner housing 112B as shown in FIG. 3. The second wall 134 is defined by the upper inner housing 112A and is preferably substantially parallel to the flexible arm 136. The upper inner housing 112A also defines a substantially rigid third wall 140 that is in contact with the first wall when the upper and lower inner housings 112A, 112B are mated. The third wall 140 provides additional rigidity to the first wall.

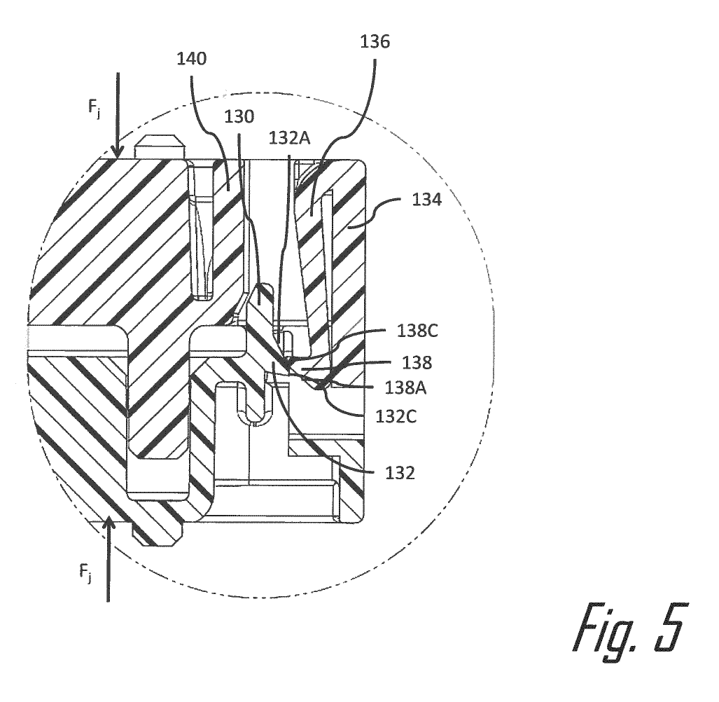

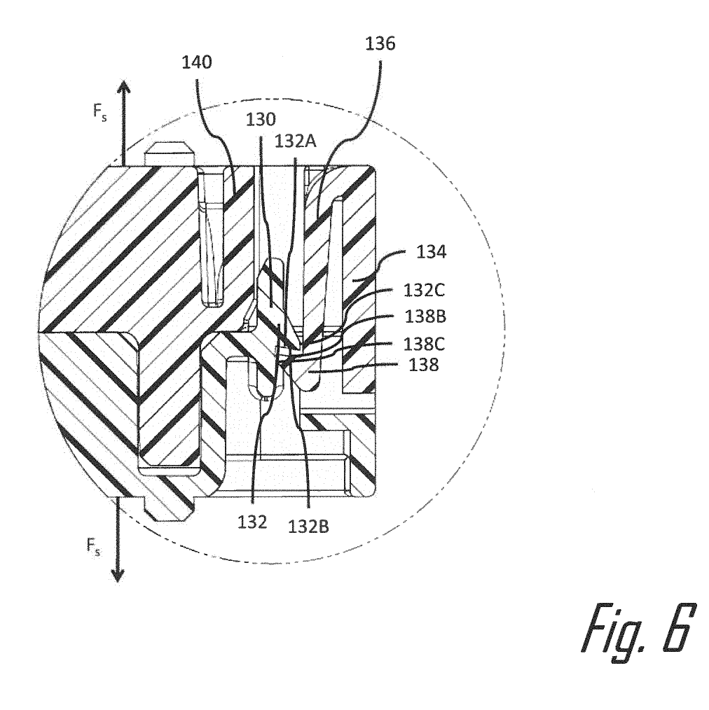

As shown in FIG. 4, a joining force F₃ is applied to the upper and lower inner housings 112A, 112B as they are joined together. Without subscribing to any particular theory of operation, as the first contact surface 132A engages the second contact surface 138A, this joining force F₃ causes the flexible arm 136 to bend toward the second wall 134. The first and second locking features 132, 138 are configured such that the first and second contact surfaces 132A, 138A are still engaged when the back side of the flexible arm 136 opposite the second locking feature 138 contacts 120 the second wall 134, thereby limiting further bending of the flexible arm 136. As the joining force F₃ remains applied to the upper and lower inner housings 112A, 112B the edge regions 132C and/or 138C deform enough to allow the first contact surface 132A to move past the second contact surface 138A. The deformation of the edge regions 132C, 138C may be elastic or plastic deformation. Once the first contact surface 132A moves past the second contact surface 138A, the resilient flexible arm 136 snaps back from contact with the second wall 134 as shown in FIG. 5, thereby allowing the first locking surface 132B to engage with the second locking surface 138 and thereby securing the upper inner housing 112A to the lower inner housing 112B.

Again, without subscribing to any particular theory of operation, disengagement of the locking surfaces is inhibited because the first and second locking surfaces 132A, 138B remain engaged even when the flexible arm 136 is deflected against the second wall 134. The angled first and second locking surfaces 132B, 138B will pull the flexible arm 136 out of contact with the second wall 134, thereby maintaining the engagement of the first and second locking surfaces 132B, 138B and increasing a separating force Fₛ, that is in a direction opposite the joining force Fⱼ, that is required to deform the edge regions 132C and/or 138C to allow disengagement of the first and second locking surfaces 132B, 138B to a level that is higher than the joining force Fⱼ. Additionally, it is more difficult to apply the separating force Fₛ to the inner housing 112 than it is to apply the joining force Fⱼ.

This tamper resistant locking feature may be adapted to other two-piece housings containing non-serviceable parts, for example housings for other electrical assemblies.

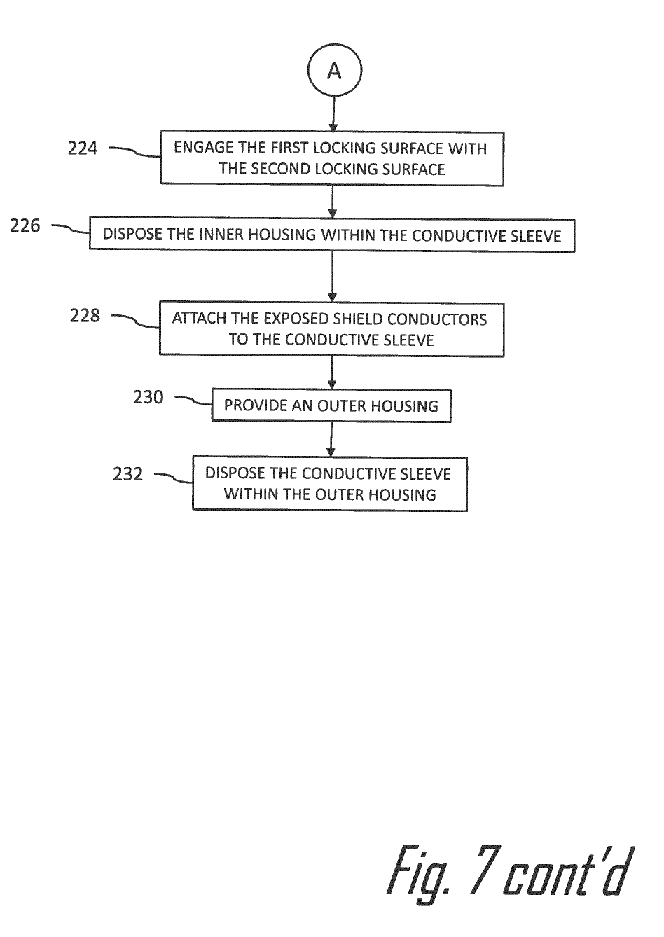

FIG. 7 illustrates a non-limiting method 200 of splicing shielded wire cables 102, 104, 106 together. The method 200 includes the following steps:

STEP 202, PROVIDE A FIRST, SECOND AND THIRD SHIELDED WIRE CABLE, includes providing a first shielded wire cable 102 having a first exposed shield conductor and a first exposed core conductor 102A, a second shielded wire cable 104 having a second exposed shield conductor and a second exposed core conductor 104A, and a third shielded wire cable 106 having a third exposed shield conductor and a third exposed core conductor 106A;

STEP 204, PROVIDE A FIRST, SECOND AND THIRD FERRULE, includes providing a first, second, and third ferrule;

STEP 206, ATTACH THE FERRULES TO SHIELD CONDUCTORS OF THE FIRST AND SECOND SHIELDED CABLES, includes attaching the first, second, and third ferrules 108 to the first, second, and third shield conductors respectively;

STEP 208, PROVIDE A BUS BAR, includes providing a generally planar bus bar 110 formed of a conductive material;

STEP 210, PROVIDE A CONDUCTIVE SLEEVE, includes providing a conductive sleeve 118;

STEP 212, PROVIDE AN INNER INSULATOR, includes providing an inner insulator formed of a thermoplastic material. The inner insulator 112 may include a upper portion 112A with a substantially rigid first wall 130 defining a first locking feature 132 and a substantially rigid second wall 134. The inner insulator 112 may also have a lower portion 112B with a flexible arm 136 defining a second locking feature 138. The first locking feature 132 includes a first contact surface 132A and a first locking surface 132B intersecting the first contact surface 132A. The second locking feature 138 includes a second contact surface 138A and a second locking surface 138 intersecting the second contact surface 138A;

STEP 214, WELD THE CORE CONDUCTORS OF THE FIRST AND SECOND SHIELDED CABLES TO THE BUS BAR, includes welding the first, second, and third exposed core conductors 102A, 104A, 106A to the bus bar 110, thereby electrically connecting the first, second, and third exposed core conductors 102A, 104A, 106A;

STEP 216, DISPOSE THE BUS BAR WITHIN THE INNER INSULATOR, includes disposing the bus bar 110 within the inner insulator 112;

STEP 218, APPLY A FORCE TO THE FIRST AND SECOND PORTIONS OF THE INNER INSULATOR, is an optional step that includes applying a joining force Fⱼ to the upper and lower portions 112A, 112B of the inner insulator 112;

STEP 220, BEND THE FLEXIBLE ARM BY ENGAGING THE FIRST CONTACT SURFACE WITH THE SECOND CONTACT SURFACE, is an optional step that includes bending the flexible arm 136 by engaging the first contact surface 132A with the second contact surface 138A as the joining force F₃ is applied to the first and second portions. The second wall 134 limits bending of the flexible arm 136;

STEP 222, DISENGAGE THE FIRST CONTACT SURFACE FROM THE SECOND CONTACT SURFACE, is an optional step that includes disengaging the first contact surface 132A from the second contact surface 138A as the joining force F₃ is applied to the upper and lower portions 112A, 112B;

STEP 224, ENGAGE THE FIRST LOCKING SURFACE WITH THE SECOND LOCKING SURFACE, is an optional step that includes engaging the first locking surface 132B with the second locking surface 138;

STEP 226, DISPOSE THE INNER HOUSING WITHIN THE CONDUCTIVE SLEEVE, includes disposing the inner housing 112 and the first, second, and third exposed shield conductors within the sleeve 118;

STEP 228, ATTACH THE EXPOSED SHIELD CONDUCTORS TO THE CONDUCTIVE SLEEVE, includes attaching the exposed shield conductors to the sleeve 118. This may be accomplished by attaching the first, second, and third contacts 120 of the sleeve 118 to the first, second, and third ferrules 108 respectively, thereby electrically interconnecting the first, second, and third shield conductors through the sleeve 118;

STEP 230, PROVIDE AN OUTER HOUSING, includes providing an outer housing 122 formed of a nonconductive material; and

STEP 232, DISPOSE THE CONDUCTIVE SLEEVE WITHIN THE OUTER HOUSING, includes disposing the sleeve 118 within the outer housing 122.

Accordingly, a wire harness assembly 100 having a splicing device and a method 200 for joining together shielded wire cables 102, 104, 106 using such a device are provided. The splicing device provides the benefit of a shorter overall length than existing splicing devices for shielded cables because it eliminates the “fan out” length. The length reduction offers advantages of packaging a wire harness assembly made with such as splicing device, for example in a motor vehicle. The inventors have observed a reduction in the overall length of the splice device of 38% compared to existing splice devices. Using cut leads rather than center stripped cables provides benefits easier processing in the for stripping, ferrule and seal attaching. The assembly 100 also includes an inner housing 112 with tamper resistant locking features 132, 138 that inhibit access to the exposed core conductors 102A, 104A, 106A, once the inner housing is assembled.

While this invention has been described in terms of the preferred embodiments thereof, it is not intended to be so limited, but rather only to the extent set forth in the claims that follow. Moreover, the use of the terms first, second, etc. does not denote any order of importance, but rather the terms first, second, etc. are used to distinguish one element from another. Furthermore, the use of the terms a, an, etc. do not denote a limitation of quantity, but rather denote the presence of at least one of the referenced items.

We claim:

1. A wire harness assembly, comprising:
a first shielded wire cable having a first exposed shield conductor and a first exposed core conductor;
a second shielded wire cable having a second exposed shield conductor and a second exposed core conductor;
a third shielded wire cable having a third exposed shield conductor and a third exposed core conductor;
a generally planar bus bar formed of a conductive material, wherein the first, second, and third exposed core conductors are welded to the bus bar, thereby electrically connecting the first, second, and third exposed core conductors;
a conductive sleeve enclosing a portion of the first, second, and third exposed shield conductors;
an inner insulator enclosing the bus bar and disposed within the conductive sleeve; and
an outer insulator enclosing the conductive sleeve.

2. The wire harness assembly according to claim 1, wherein the inner insulator further comprises:
a first portion having a substantially rigid first wall defining a first locking feature and a substantially rigid second wall, wherein the first locking feature includes a first contact surface and a first locking surface intersecting the first contact surface;
a second portion having a flexible arm defining a second locking feature, wherein the second locking feature includes a second contact surface and a second locking surface intersecting the second contact surface, wherein the first contact surface engages the second contact surface causing the flexible arm to bend as the first portion is joined to the second portion, wherein the second wall limits bending of the flexible arm, and wherein the first locking feature and/or the second locking feature at least temporarily deforms when the bending of the flexible arm is limited by the second wall as the first portion is joined to the second portion, said deformation disengaging the first contact surface from the second contact surface and thereby allowing the first locking surface to engage with the second locking surface.

3. The wire harness assembly according to claim 2, wherein the second wall is defined by the second portion.

4. The wire harness assembly according to claim 3, wherein the second wall is substantially parallel to the flexible arm.

5. The wire harness assembly according to claim 2, wherein the first wall is in contact with a substantially rigid third wall defined by the second portion.

6. A method of splicing shielded wire cables together, comprising the steps of:
providing a first shielded wire cable having a first exposed shield conductor and a first exposed core conductor;
providing a second shielded wire cable having a second exposed shield conductor and a second exposed core conductor;
providing a third shielded wire cable having a third exposed shield conductor and a third exposed core conductor;
providing a first, second, and third ferrule;
attaching the first, second, and third ferrules to the first, second, and third shield conductors respectively;
providing a generally planar bus bar formed of a conductive material;
providing a conductive sleeve;
providing an inner insulator formed of a thermoplastic material;
disposing the bus bar within the inner insulator;
welding the first, second, and third exposed core conductors to the bus bar, thereby electrically connecting the first, second, and third exposed core conductors;
disposing the inner insulator and the first, second, and third exposed shield conductors within the conductive sleeve;
attaching the first, second, and third ferrules to the conductive sleeve, thereby providing a conductive path between the first, second, and third exposed shield conductors;
providing an outer insulator formed of a nonconductive material; and
disposing the conductive sleeve within the outer insulator.

7. The method according to claim 6, wherein the inner insulator further comprises a first portion having a substantially rigid first wall defining a first locking feature and a substantially rigid second wall and a second portion having a flexible arm defining a second locking feature, wherein the first locking feature includes a first contact surface and a first locking surface intersecting the first contact surface, wherein the second locking feature includes a second contact surface and a second locking surface intersecting the second contact surface, and wherein the method further comprises the steps of:
applying a force to the first and second portions,
bending the flexible arm by engaging the first contact surface with the second contact surface as the force is applied to the first and second portions, wherein the second wall limits bending of the flexible arm,
at least temporarily deforming the first locking feature and/or the second locking feature as the bending of the flexible arm is limited by the second wall as the force is applied to the first and second portions,
disengaging the first contact surface from the second contact surface as the force is applied to the first and second portions, and
engaging the first locking surface with the second locking surface.

8. The method according to claim 7, wherein the second wall is defined by the second portion.

9. The method according to claim 8, wherein the second wall is substantially parallel to the flexible arm.

10. The method according to claim 7, wherein the first wall is in contact with a substantially rigid third wall defined by the second portion.

11. A tamper resistant housing, comprising:
a first portion having a substantially rigid first wall defining a first locking feature and a substantially rigid second wall, wherein the first locking feature includes a first contact surface and a first locking surface intersecting the first contact surface;
a second portion having a flexible arm defining a second locking feature, wherein the second locking feature includes a second contact surface and a second locking surface intersecting the second contact surface, wherein the first contact surface engages the second contact surface causing the flexible arm to bend as the first portion is joined to the second portion, wherein the second wall limits bending of the flexible arm, and wherein the first locking feature and/or the second locking feature at least temporarily deforms when the bending of the flexible arm is limited by the second wall as the first portion is joined to the second portion, said deformation disengaging the first contact surface from the second contact surface and thereby allowing the first locking surface to engage with the second locking surface.

12. The tamper resistant housing according to claim 11, wherein the second wall is defined by the second portion.

13. The tamper resistant housing according to claim 12, wherein the second wall is substantially parallel to the flexible arm.

14. The tamper resistant housing according to claim 11, wherein the first wall is in contact with a substantially rigid third wall defined by the second portion.

15. The tamper resistant housing according to claim 11, wherein the first and second portions are formed of an insulative polymeric material.
